(19) United States
(12) Patent Application Publication
(10) Pub. No.: US 2008/0079553 A1
(43) Pub. Date: Apr. 3, 2008

(54) TURN SIGNAL INTEGRATED CAMERA SYSTEM

(76) Inventor: STEVEN JAMES BOICE, AUSTIN, TX (US)

Correspondence Address: STEVEN JAMES BOICE, 1902 STONERIDGE ROAD, AUSTIN, TX, 78746, US

(21) Appl. No.: 11/537,774

(22) Filed: Oct. 2, 2006

(51) Int. Cl. B60Q 1/00; H04N 7/18

(52) U.S. Cl. 340/435; 348/148

(57) ABSTRACT

In order to enable a driver to see areas in a blind spot, operation of a turn signal is integrated with an exterior vehicle-mounted camera and an on-board video display that is located in a cabin of the vehicle. Whenever a turn signal is activated, a camera feed from a vehicle-mounted external camera is sent to the on-board video display, thus providing the driver with a real-time view of the blind spot.

### BACKGROUND OF THE INVENTION

1. Technical Field

The present invention relates in general to the field of vehicles, and more particularly to vehicles equipped with driver-viewable video displays. Still more particularly, the present invention relates to vehicles that have a “blind spot” from a driver's cabin position.

2. Description of the Related Art

“Blind spots” are common hazards to vehicle drivers. A “blind spot” is defined as an area proximate to a vehicle in which objects are not visually apparent to a driver. That is, a blind spot includes an area near the vehicle in which hazards are not seen by the driver, either through the use of central and side mirrors, or through unaided vision, including peripheral vision. If a driver does not see a hazard in the blind spot, then there is a high likelihood that the driver's vehicle, when turning or changing lanes, will hit that object, which may be another vehicle, a pedestrian, a fixed object, etc.

In some cases, a driver can see objects in a blind spot by twisting his head around to look directly at the blind spot. However, this causes him to take his eyes completely away from the on-coming road, and often results in dangerous unintended movement of the steering wheel.

### SUMMARY OF THE INVENTION

In order to enable a driver to safely see areas in a blind spot, the present invention integrates an operation of a turn signal with an exterior vehicle-mounted camera and an on-board video display that is located in a cabin of the vehicle. In a preferred embodiment, whenever a turn signal is activated, a camera feed from a vehicle-mounted external camera is sent to the on-board video display, thus providing the driver with a real-time view of the blind spot.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIGS. 1A-B depict a vehicle with a vehicle-mounted external camera whose field of view is directed to a blind spot of a driver of the vehicle;

FIG. 2 illustrates an on-board video display located in a dashboard of the vehicle depicted in FIGS. 1A-B, wherein the on-board video display shows a real-time view of the blind spot;

FIG. 3 illustrates an exemplary on-board computer and service provider server in which the present invention may be utilized;

FIG. 4 is a flow-chart of exemplary steps taken by the present invention to display a view of a blind spot on the on-board video display when a turn signal on the vehicle is turned on; and

FIG. 5 is a flow-chart of exemplary steps taken b the present invention to display a view of a blind spot on the on-board video display when the vehicle is executing a turn.

### DETAILED DESCRIPTION OF THE PREFERRED EMBODIMENT

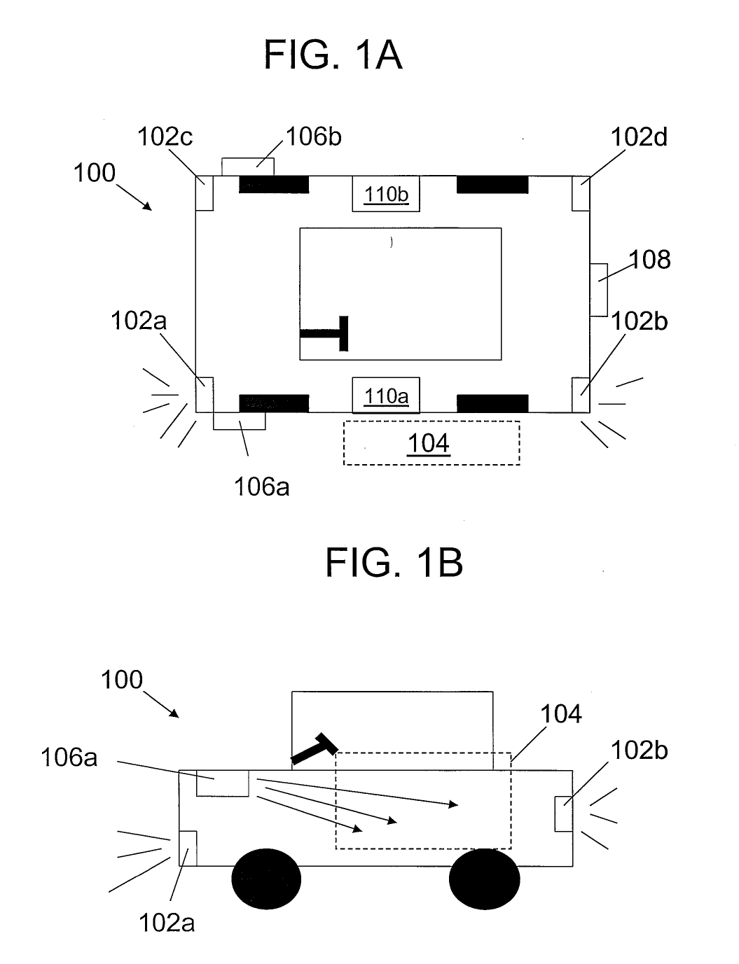

With reference now to the figures and in particular to FIGS. 1A-B, a vehicle 100 is presented. Note that while vehicle 100 is presented for exemplary purposes, and as a preferred embodiment, as an automobile, vehicle 100 may be any vehicle, including but not limited to trucks, buses, aircraft, water craft, construction equipment (e.g., forklifts, graders, etc.), agricultural equipment (e.g., tractors, combines, etc.), and any other vehicle capable of transporting passengers and/or material, and/or performing work during vehicle movement.

Vehicle 100 includes multiple turn signals 102a-d. Note that for illustrative purposes, the left turn signals 102A-B as shown as being illuminated, suggesting that a driver of vehicle 100 desires to drive to the left (either to make a turn or to change lanes in a multi-lane road). Problematic for the driver of vehicle 100 is a blind spot 104, which, if seen at all, is visible only by the driver twisting his head around in a manner that requires him to take his eyes off the road in front of him. However, in accordance with the present invention, vehicle 100 has vehicle-mounted cameras 106A-B. As depicted, vehicle-mounted camera 106a has a field of view that is directed to the blind spot 104. In a preferred embodiment, each vehicle-mounted camera 106A-B is discretely hidden for security reasons.

In an alternate embodiment, vehicle 100 also includes one or more proximity sensors 110, depicted in FIG. 1A as proximity sensors 110a-b. If an object is within blind spot 104, proximity sensor 110a detects its presence. This detection may be utilized to present an aural and/or visual cue to the driver of vehicle 100. For example, a Heads-Up Display (HUD), a signal in a gauge panel, etc. may present to the driver a visual and/or aural cue that the object is located within the blind spot 104 on the left side of the vehicle 100.

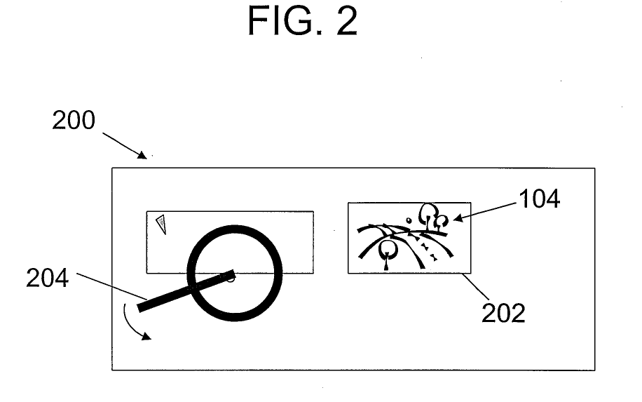

Referring now to FIG. 2, a dashboard 200 located in the cabin of vehicle 100 shown in FIGS. 1A-B, includes an on-board video display 202. As suggested by the figure, a turn signal arm 204 has been pulled downward, thus activating left turn signals 102A-B. In a manner described in further detail below, this activation of left turn signals 102A-B causes a video feed from vehicle-mounted camera 106a to be displayed on on-board video display 202. When turn signal arm 204 returns to a neutral position (no longer causing left turn signals 102A-B to flash), then the display on on-board video display 202 returns to whatever was being displayed before the turn signal arm 204 was engaged.

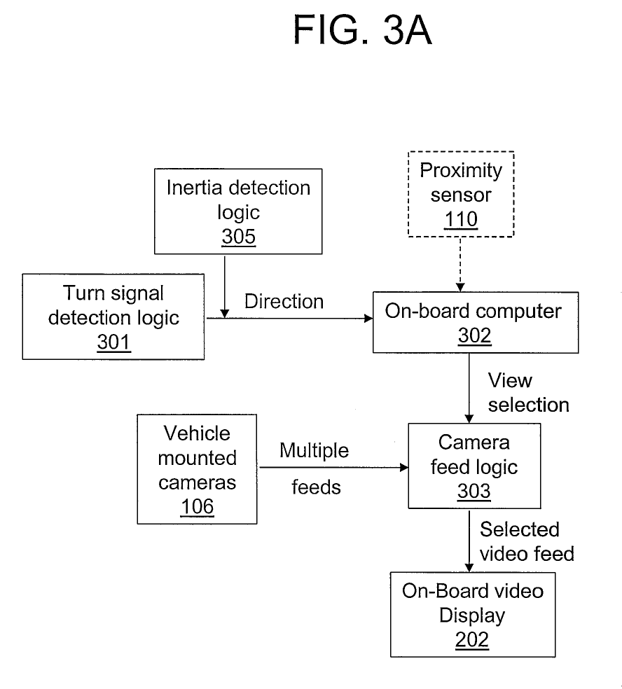

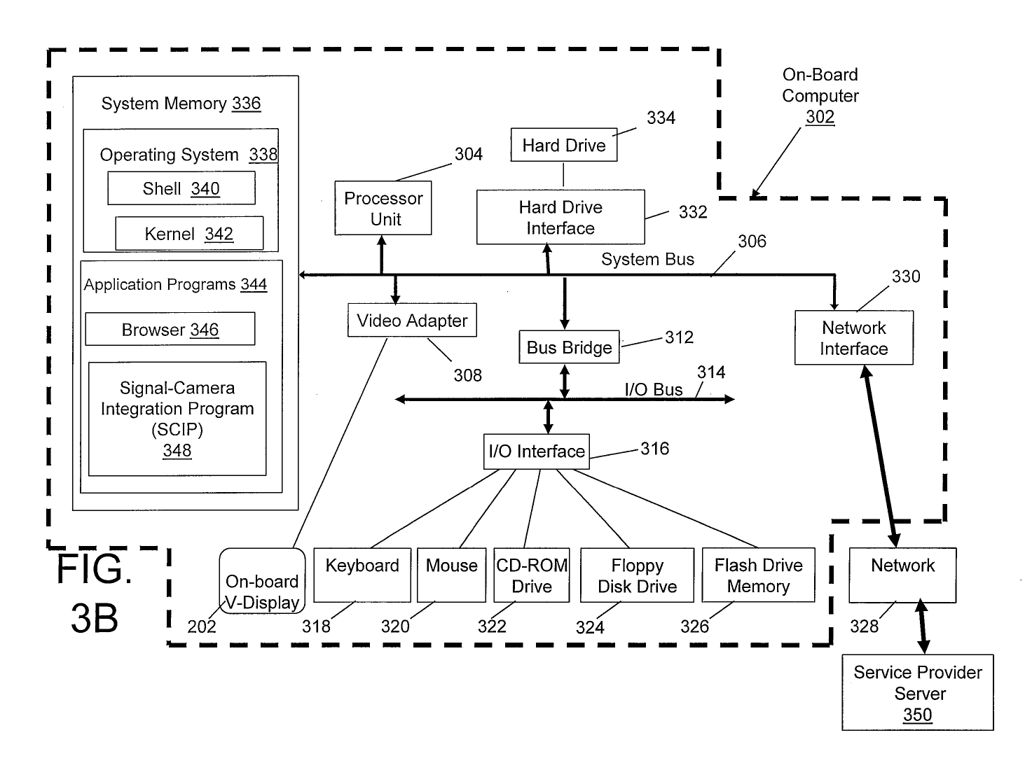

Thus, a high-level overview of components utilized by the present invention is shown in FIG. 3A. As illustrated, a turn signal detection logic 301 detects that a turn signal has been engaged, and also detects whether the turn signal is for a left blinker or a right blinker. Alternatively, an inertial detection logic 305 may sense that the vehicle has changed directions, to a degree that the vehicle may strike an object that is in the block spot 104. Inertial detection logic 305 may be composed of any logic known to those skilled in the art, including but not limited to three-axis inertia detectors. This direction information (either from the turn signal being activated or from the inertia detection logic) is sent to an on-board computer 302 in a vehicle, which sends an instruction to a camera feed logic 303. This instruction tells the camera feed logic 303 which direction (left or right) has been signaled. From this information, the camera feed logic 303 selects a camera feed from one of the multiple vehicle-mounted cameras 106 (shown in FIGS. 1A-B as vehicle-mounted cameras 106a-d) that is appropriate. For example, if the turn signal indicates a left turn, then video feed from the vehicle-mounted camera on the left side of the vehicle will be sent to on-board video display 202. Similarly, if the turn signal had indicated a right turn, then video feed from the vehicle-mounted camera on the left side of the vehicle would have been sent to on-board video display 202. Note further that the proximity sensor 110 may be used to alert a driver of the vehicle that an object is located in the blind spot of the vehicle, thus providing an alert cue to the driver to look at the on-board video display 202 in order to identify the detected object.

With reference now to FIG. 3B, there is depicted a block diagram of an exemplary on-board computer 302, in which the present invention may be utilized. On-board computer 302 includes a processor unit 304 that is coupled to a system bus 306. A video adapter 308, which drives/supports a on-board video display 310, is also coupled to system bus 306. System bus 306 is coupled via a bus bridge 312 to an Input/Output (I/O) bus 314. An I/O interface 316 is coupled to I/O bus 314. I/O interface 316 affords communication with various I/O devices, including a keyboard 318, a mouse 320, a Compact Disk—Read Only Memory (CD-ROM) drive 322, a floppy disk drive 324, and a flash drive memory 326. The format of the ports connected to I/O interface 316 may be any known to those skilled in the art of computer architecture, including but not limited to Universal Selial Bus (USB) ports.

On-board computer 302 is able to communicate with a service provider server 350 via a network 328 using a network interface 330, which is coupled to system bus 306. Network 328 may be an external network such as the Internet, or an internal network such as an Ethernet or a Virtual Private Network (VPN). Note the service provider server 350 may utilize a same or substantially similar architecture as on-board computer 302.

A hard drive interface 332 is also coupled to system bus 306. Hard drive interface 332 interfaces with a hard drive 334. In a preferred embodiment, hard drive 334 populates a system memory 336, which is also coupled to system bus 306. System memory is defined as a lowest level of volatile memory in on-board computer 302. This volatile memory includes additional higher levels of volatile memory (not shown), including, but not limited to, cache memory, registers and buffers. Data that populates system memory 336 includes on-board computer 302's operating system (OS) 338 and application programs 344.

OS 338 includes a shell 340, for providing transparent user access to resources such as application programs 344. Generally, shell 340 is a program that provides an interpreter and an interface between the user and the operating system. More specifically, shell 340 executes commands that are entered into a command line user interface or from a file. Thus, shell 340 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 342) for processing. Note that while shell 340 is a text-based, line-oriented user interface, the present invention will equally well support other user interface modes, such as graphical, voice, gestural, etc.

As depicted, OS 338 also includes kernel 342, which includes lower levels of functionality for OS 338, including providing essential services required by other parts of OS 338 and application programs 344, including memory management, process and task management, disk management, and mouse and keyboard management.

Application programs 344 include a browser 346. Browser 346 includes program modules and instructions enabling a World Wide Web (WWW) client (i.e., on-board computer 302) to send and receive network messages to the Internet using HyperText Transfer Protocol (HTTP) messaging, thus enabling communication with service provider server 350.

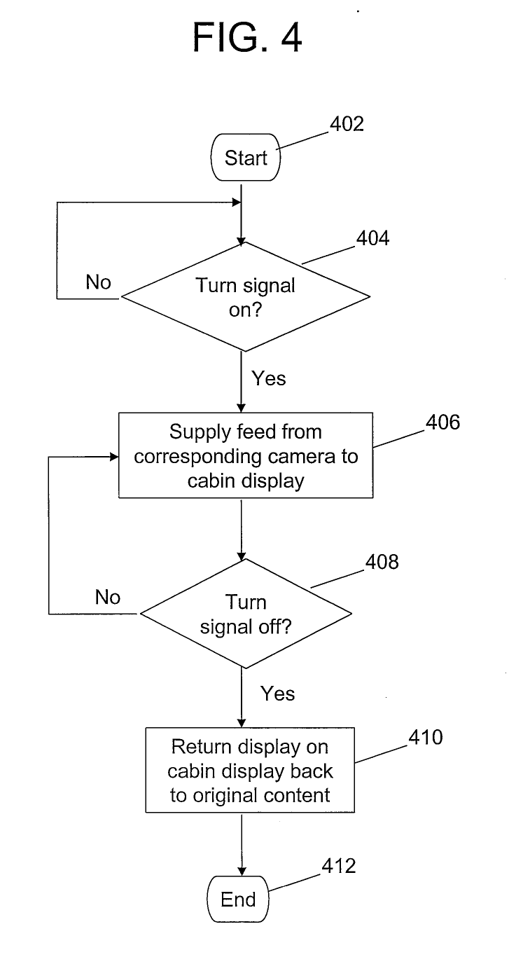

Application programs 344 in on-board computer 302's system memory (as well as service provider server 350's system memory) also include a Signal-Camera Integration Program (SCIP) 348. SCIP 348 includes code for implementing the processes described in FIGS. 3A and 4.

The hardware elements depicted in on-board computer 302 are not intended to be exhaustive, but rather are representative to highlight essential components required by the present invention. For instance, on-board computer 302 may include alternate memory storage devices such as magnetic cassettes, Digital Versatile Disks (DVDs), Bernoulli cartridges, and the like. These and other variations are intended to be within the spirit and scope of the present invention.

Note further that, in a preferred embodiment of the present invention, service provider server 350 performs all of the functions associated with the present invention (including execution of SCIP 348), thus freeing on-board computer 302 from having to use its own internal computing resources to execute SCIP 348.

With reference now to FIG. 4, a high-level flow-chart of exemplary steps taken by the present invention is presented. After initiator block 402, a query is made to determine if a turn signal has been activated (query block 404). If so, then a video feed selection logic (e.g., camera feed logic 303 shown in FIG. 3A) selects (block 406) a video feed from an appropriate camera (left camera for left turn, right camera for right turn), which is displayed on the on-board video display 202. The step shown in block 406 assumes that all cameras 106 are continuously turned on. Alternatively, when a left turn signal is detected, then a left-side camera 106a can be turned on, such that the only feed coming into camera feed logic 303 (and ultimately on-board video display 202) is that coming from the turned on camera. Once the turn signal arm 204 is returned to its original position (block 408), then the display on the on-board video display 202 returns to what was being displayed before the turn signal was activated (block 410), and the process ends (terminator block 412).

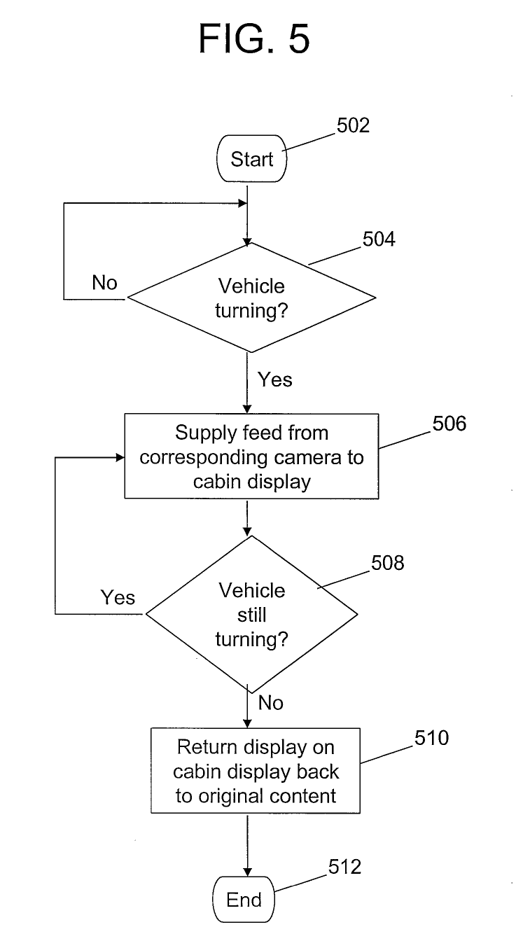

With reference now to FIG. 5, an alternate use of the on-board video display 202 and cameras 106 is presented. After initiator block 502, a determination is made that the vehicle is turning (query block 504) at a rate sufficient to cause the vehicle to strike an object that may be in its blind spot. Upon this determination, a video feed selection logic (e.g., camera feed logic 303 shown in FIG. 3A) selects (block 506) a video feed from an appropriate camera (left camera for leftward movement, right camera for rightward movement), which is displayed on the on-board video display 202. The step shown in block 506 assumes that all cameras 106 are continuously turned on. Alternatively, when a left turn signal is detected, then a left-side camera 106a can be turned on, such that the only feed coming into camera feed logic 303 (and ultimately on-board video display 202) is that coming from the turned on camera. Once the vehicle is no longer turning (query block 508), then the on-board video display 202 returns to displaying what was being displayed before the vehicle began turning (block 510), and the process ends (terminator block 512).

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

The present invention thus assists a driver of a vehicle by providing that driver with a view of a blind spot of the vehicle, such that the blind spot is effectively eliminated. In a preferred embodiment, the present invention provides for a method that includes the steps of: detecting an activation of a turn-signal mechanism; determining a direction of a turn-signal associated with the turn-signal mechanism; and supplying a video feed from a vehicle-mounted camera to an on-board video display, wherein the vehicle-mounted camera has a field of view that includes a blind spot in the direction of the turn-signal. The method may further include the step of, in response to the turn-signal mechanism being turned off, returning a display on the on-board video display to a pre-turn display of information that was presented before the turn-signal mechanism was activated. The pre-turn display may be a Global Positioning Satellite (GPS) based map. Furthermore, the video feed may be selected, by a camera feed logic, from a plurality of vehicle-mounted cameras. Alternatively, the video feed is created by activating, from a plurality of vehicle-mounted cameras, a specific vehicle-mounted camera that has the field of view of the includes the blind spot. The vehicle may be an earth-moving piece of powered equipment (e.g., a bulldozer, a grader, a front-end loader, etc.), or a transportation vehicle (e.g., a car, trick, bus, aircraft, watercraft, etc.).

The inventive vehicle includes: a turn signal activation mechanism; a turn signal detection logic that detects: a direction of a turn signal, and an activation of the turn signal activation mechanism; at least one vehicle-mounted cameras; a camera feed logic; and an on-board video display, wherein the camera feed logic selects a video feed from one or more of the at least one vehicle-mounted cameras to the on-board video display, and wherein a selected video feed is from a vehicle-mounted camera having a field of view of a blind spot that is in the direction of the turn signal. The at least one vehicle-mounted cameras may be a single camera that has a field of view of all blind spots for the vehicle. Each blind spot of the vehicle may have a dedicated vehicle-mounted camera. As noted above, the vehicle may be an earth-moving piece of powered equipment (e.g., a bulldozer, a grader, a front-end loader, etc.), or a transportation vehicle (e.g., a car, truck, bus, aircraft, watercraft, etc.). The on-board video display may be an in-dash display that is capable of displaying Global Positioning Satellite (GPS) based map information.

Furthermore, the present invention describes and claims a system that includes, but is not limited to, a turn signal activation mechanism; a turn signal detection logic that detects a direction of a turn signal, and an activation of the turn signal activation mechanism; at least one vehicle-mounted cameras; a camera feed logic; and an on-board video display, wherein the camera feed logic selects a video feed from one or more of the at least one vehicle-mounted cameras to the on-board video display, and wherein a selected video feed is from a vehicle-mounted camera having a field of view of a blind spot of a vehicle that is in the direction of the turn signal. The at least one vehicle-mounted cameras may be a single camera that has a field of view of all blind spots for the vehicle. Alternatively, each blind spot of the vehicle has a dedicated vehicle-mounted camera. As noted above, the on-board video display may be an in-dash display that is capable of displaying Global Positioning Satellite (GPS) based map information.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A method for eliminating a blind spot in a vehicle, the method comprising:
detecting an activation of a turn-signal mechanism;
determining a direction of a turn-signal associated with the turn-signal mechanism; and
supplying a video feed from a vehicle-mounted camera to an on-board video display, wherein the vehicle-mounted camera has a field of view that includes a blind spot in the direction of the turn-signal.

2. The method of claim 1, further comprising:
in response to the turn-signal mechanism being turned off, returning a display on the on-board video display to a pre-turn display of information that was presented before the turn-signal mechanism was activated.

3. The method of claim 2, wherein the pre-turn display is a Global Positioning Satellite (GPS) based map.

4. The method of claim 1, wherein the video feed is selected, by a camera feed logic, from a plurality of vehicle-mounted cameras.

5. The method of claim 1, wherein the video feed is created by activating, from a plurality of vehicle-mounted cameras, a specific vehicle-mounted camera that has the field of view of the includes the blind spot.

6. The method of claim 1, further comprising:
receiving a proximity signal from a proximity sensor that is mounted on the vehicle, wherein the proximity signal indicates a presence of an object in the blind spot; and
in response to receiving the proximity signal, providing a warning cue to a driver of the vehicle indicating that the object is in the blind spot.

7. The method of claim 1, wherein the vehicle is a transportation vehicle.

8. The method of claim 6, further comprising:
determining that the vehicle is in a turn, wherein the turn is at a rate that is sufficient to cause the vehicle to strike an object that may be in its blind spot; and
in response to determining the turn, selecting a selected video feed from an appropriate camera aimed in a direction of the turn; and
displaying the selected video feed on the on-board video display.

9. A vehicle comprising:
a turn signal activation mechanism;
a turn signal detection logic that detects:
a direction of a turn signal, and
an activation of the turn signal activation mechanism;
at least one vehicle-mounted camera;
a camera feed logic; and
an on-board video display, wherein the camera feed logic selects a video feed from one or more of the at least one vehicle-mounted cameras to the on-board video display, and wherein a selected video feed is from a vehicle-mounted camera having a field of view of a blind spot that is in the direction of the turn signal.

10. The vehicle of claim 8, wherein the at least one vehicle-mounted cameras is a single camera that has a field of view of all blind spots for the vehicle.

11. The vehicle of claim 8, wherein each blind spot of the vehicle has a dedicated vehicle-mounted camera.

12. The vehicle of claim 9, wherein the vehicle is an automobile.

13. The vehicle of claim 9, wherein the vehicle is a forklift.

14. The vehicle of claim 9, wherein the vehicle is a bus.

15. The vehicle of claim 9, further comprising:
a proximity sensor that is mounted on the vehicle, wherein a proximity signal from the proximity sensor indicates a presence of an object in the blind spot; and
a warning device in a cabin of the vehicle, wherein the warning device provides a warning cue to a driver of the vehicle indicating that the object is in the blind spot.

16. The vehicle of claim 9, wherein the on-board video display is an in-dash display that is capable of displaying Global Positioning Satellite (GPS) based map information.

17. A system comprising:
a turn signal activation mechanism;
a turn signal detection logic that detects:
a direction of a turn signal, and
an activation of the turn signal activation mechanism;
at least one vehicle-mounted camera;
a camera feed logic; and
an on-board video display, wherein the camera feed logic selects a video feed from one or more of the at least one vehicle-mounted cameras to the on-board video display, and wherein a selected video feed is from a vehicle-mounted camera having a field of view of a blind spot of a vehicle that is in the direction of the turn signal.

18. The system of claim 17, wherein the at least one vehicle-mounted cameras is a single camera that has a field of view of all blind spots for the vehicle.

19. The system of claim 17, further comprising:
a proximity sensor that is mounted on the vehicle, wherein a proximity signal from the proximity sensor indicates a presence of an object in the blind spot; and
a warning device in a cabin of the vehicle, wherein the warning device provides a warning cue to a driver of the vehicle indicating that the object is in the blind spot.

20. The system of claim 17, wherein the on-board video display is an in-dash display that is capable of displaying Global Positioning Satellite (GPS) based map information.
